(19) United States
(12) Patent Application Publication
(10) Pub. No.: US 2004/0085560 A1
(43) Pub. Date: May 6, 2004

(54) Selectively printing document pages

(76) Inventor: Gary G. Stringham, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/284,099

(22) Filed: Oct. 31, 2002

(51) Int. Cl. G06F 3/12; G06F 13/00

(52) U.S. Cl. 358/1.13; 358/1.16

(57) ABSTRACT

In one embodiment, a method, whereby, at least one page of a document is printed at a printing device having a control panel. In the method, a document file is stored in a memory of the printing device. The printing device receives instructions through the control panel to print one or more selected pages of the document and the one or more selected pages of the document is printed.

### FIELD OF THE INVENTION

This invention relates generally to printing devices. More particularly, the invention pertains to techniques for printing one or more selected pages of documents.

### BACKGROUND OF THE INVENTION

It is generally known that printing devices, e.g., inkjet printers, laser printers, photocopiers, facsimile machines, etc., may be configured to store one or more document files. In addition, printing devices on a network are generally configured to receive and store multiple documents from multiple users at any one time. For example, printing devices are often connected via networks to computing implements, e.g., computers, personal digital assistants (PDAs), UNIX, etc., to enable multiple users access to the printing devices.

Conventional printing devices do not provide a user the ability to selectively print pages of the stored documents. Instead, printing devices are often configured to print each page of a selected document. The selection to print certain pages of a document is limited through use of a computing platform. In this regard, users are unable to selectively print pages of a document solely through a conventional printing device. Thus, if a user desires to print or re-print only certain pages of a document, the user must re-send the printing instruction from the computing platform.

In addition, computing platforms are often unable to display the pages of the stored documents. As an example, PDAs or personal information management devices often include relatively small screens which are incapable of displaying the manner in which the documents created thereon will appear as printed. In addition, those computing implements, e.g., personal computers including a screen, that are capable of displaying the documents, may be unable to accurately display the manner in which the documents may be printed. This may lead to wasted time and energy as the user may be required to travel back and forth from the computing platform to the printing device.

Reliance on the display of the document images on a screen of a PDA or other computing implement may yield a variety of drawbacks and disadvantages. As an example, print media implemented to receive the printed document may be wasted, as well as the image forming material, e.g., ink, toner, etc., in printing documents that are not formatted in a desired manner. In addition, a user's time may also be inefficiently expended because the user may be required to perform multiple manipulations of the document format in order to print the document in the desired manner.

Printing devices are often equipped to store multiple pages of a stored document as they are printed, e.g., in a bin. The pages are typically stored to enable them to be bound together or sorted. As the sheets are printed upon and stored, the user is typically unable to see which of the pages have been printed accurately, e.g., without substantial defects. Therefore, the user is often required to wait until the entire document has been printed before noticing that one or more of the pages have defects. This may lead to wasted time as the user may be required to wait by the printing device for an extended period of time.

### SUMMARY OF THE INVENTION

According to an embodiment, the invention pertains to a method for printing one or more pages of a document at a printing device having a control panel. In the method, a document file is stored in a memory of the printing device. The printing device receives instructions through the control panel to print one or more selected pages of the document and the one or more selected pages of the document is printed.

According to another embodiment, the invention relates to a printing device for printing at least one selected page of a document. The printing device includes a print module for printing documents, a controller coupled to the print module, and a memory coupled to the controller for storing one or more documents. In addition, the printing device includes a control panel operable to receive instructions to print at least one selected page of the one or more documents. The controller is also configured to control the print module to print the selected at least one page.

According to yet another embodiment, the invention pertains to a computer readable storage medium on which is embedded one or more computer programs. The one or more computer programs implement a method for printing one or more pages of a document in a printing device having a control panel. The one or more computer programs include a set of instructions for storing one or more document files in a memory of the printing device, receiving instructions through the control panel to print one or more selected pages of the document, and printing the one or more selected pages of the document.

### BRIEF DESCRIPTION OF THE DRAWINGS

Features and aspects of the present invention will become apparent to those skilled in the art from the following description with reference to the figures, in which:

FIG. 1 is an exemplary block diagram of a host device and a printing device in accordance with an embodiment of the present invention;

FIG. 2 is an exemplary block diagram of a plurality of host devices, a printing device and a server in accordance with another embodiment of the present invention;

FIG. 3 is an exemplary flow diagram of a method according to an embodiment of the present invention;

FIG. 4 is an exemplary flow diagram of a method according to another embodiment of the present invention; and

FIG. 5 is an exemplary screenshot of a plurality of document images according to an embodiment of the present invention.

### DETAILED DESCRIPTION OF THE INVENTION

For simplicity and illustrative purposes, principles of the present invention are described by referring mainly to exemplary embodiments thereof. In the following description, numerous specific details are set forth in order to provide a thorough understanding of the present invention. It will be apparent however, to one of ordinary skill in the art, that the present invention may be practiced without limitation to these specific details. In other instances, well known methods and structure have not been described in detail so as not to unnecessarily obscure the present invention.

According to an embodiment of the invention, a printing device may be implemented to print selected pages of a document. For instance, a user may select to print certain pages of a document that has been sent to the printing device. The selection may be made through a control panel of the printing device. In addition, the selected pages may be displayed on the display panel prior to or during printing of the selected pages. The displayed image on the display panel may include a relatively low-resolution image, preferably in the form of a thumbnail view, of one or more selected pages of the document. Alternatively, the displayed image may comprise a relatively larger image of a portion of at least one selected page of the document.

In one respect, a user may selectively print pages of documents stored in the printing device memory. In addition, the user may view the selected pages of the documents, to determine if the selected pages are the appropriate ones to print. Further, the user may view the documents prior to printing thereof and/or during printing of the documents on the graphical display panel.

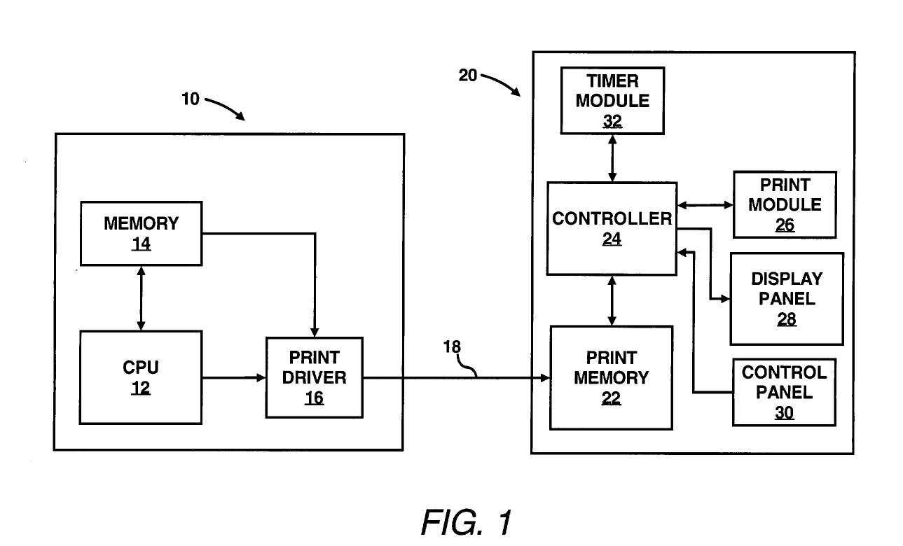

In FIG. 1, there is illustrated an exemplary block diagram of a host device 10 and a printing device 20 in accordance with an embodiment of the present invention. As will become better understood from a reading of the present disclosure, the following description of the block diagram illustrates one manner in which a printing device 20 having a display panel 28 may be operated in accordance with an embodiment of the present invention. In this respect, it is to be understood that the following description of FIG. 1 is but one manner of a variety of different manners in which such a printing device 20 may be configured.

Although not shown in FIG. 1, a monitor may be coupled to the host device 10 to display visual information to an operator, such as the printing device 20 status or a particular program being executed on the host device 10. In addition, input/output devices, such as a keyboard and/or a mouse device, and monitor or other similar devices may also be coupled to the host device 10.

The host device 10, for example, a computer, laptop computer, scanning apparatus (e.g., photocopier, facsimile machine, etc.), PDA, and the like, may include any number of peripheral devices, e.g., modem, sound card, video card, etc. In addition, the host device 10 may include a device (not shown) that enables wireless communication (e.g., IR, optical, RF, and like wireless mechanisms).

The printing device 20, e.g., printer, photocopier, facsimile machine, etc., may include any number of components not specifically illustrated in FIG. 1. For example, the printing device 20 may contain electronics (not shown) configured to provide an interface between the controller 24 and the print module 26.

The host device 10 may include a central processing unit (CPU) 12 configured to execute application software that may pass print commands, e.g., send a file from a memory 14 to the printing device 20 for printing. A print driver 16 is coupled to the CPU 12 and generally operates to format document files stored in memory 14 for printing at the printing device 20. In addition, the host device 10 may include a scanning device (not shown) to optically scan pages of documents that may be stored in the memory 14. As an example, the scanning device may form part of a photocopier machine.

The printing device 20 may be physically attached to the host device 10 via a communication line 18. Alternatively, the printing device 20 may be wirelessly coupled to the host device 10. More specifically, the printing device 20 may include a device (not shown) that enables communication with the wireless communication device disposed in the host device 10. In addition, the host device 10 and the printing device 20 may communicate using a wireless communication protocol such as BLUETOOTH.

The printing device 20 may include a controller 24 that executes a set of programs stored in a print memory 22. These programs include, for example, receipt of instructions to print selected pages of a document and printing the selected pages with the print module 26. In addition, the programs may be implemented to enable communication between the printing device 20 and the host device 10 and that further enable the printing of documents supplied to the printing device 20 by the host device 10 may be stored in the print memory 22. In addition to these programs, the print memory 22 may include one or more directories designated to store document files received by the printing device 20 from the host device 10.

The controller 24 may be configured to provide control logic for the printing device 20, which provides the functionality for the printing device. In this respect, the controller 24 may be implemented by a microprocessor, a micro-controller, an application specific integrated circuit (ASIC), and the like. The controller 24 may be interfaced with a print memory 22 configured to provide storage of programming that provides the functionality of the printing device 20 and may be executed by the controller. The print memory 22 may also be configured to provide a temporary storage area for data/file received by the printing device 20 from the host device 10.

The print memory 22 may be implemented by volatile, non-volatile or a combination of volatile and non-volatile memory, such as dynamic random access memory (RAM), EEPROM, flash memory, and the like.

The printing device 20 further includes a print module 26 that, under the control of the controller 24, enables the printing of documents. The print module 26 may be implemented using any combination of hardware, firmware and software programming necessary to enable printer functionality. Furthermore, although depicted as separate components, the controller 24 and the print module 26 may be combined to form a single module or unit.

A display panel 28, e.g., an alpha-numeric display device, a liquid crystal display device, graphical user interface, etc., may be disposed on the printing device 20 for displaying information generated by the controller 24. The display panel 28 may comprise a relatively small screen and may display images (e.g., alpha-numeric and other symbols, pictures, etc.) with relatively low resolution. In addition, the display panel 28 may display information such as toner and ink levels, locations of paper jams, and other similar status information. Moreover, the display panel 28 may function as an input device. In this respect, the display panel 28 may comprise a touch sensitive screen configured as a control panel 30 to receive user commands.

One or more programs stored in the print memory 22 may enable control of the display panel 28 by the controller 24. In addition, a control panel 30 may be disposed in the printing device 20 at a location near the display panel 28 so that the user may supply information to the controller 24 while viewing the display panel 28. The control panel 30 may include a numeric keypad, for example, configured to receive input from a user to operate the functionality of the printing device 20. The control panel 30 may also comprise, for example, a multi-function keypad configured to enable selection of pages, an alpha-numeric keypad, a keyboard, one or more input mechanisms (e.g., push button controllers, dials, etc.), and like input devices. Further, the control panel 30 may be integrated with the display panel 28 to form a single user interface, e.g., the display panel 28 may include a set of keys and may be touch sensitive.

The printing device 20 may also include a timer module 32 designed to automatically initiate printing of a document absent user input. The timer module 32 may comprise any reasonably suitable hardware device or programming configured to perform the above-described function. Alternatively, the timer module 32 may be incorporated into the controller 24.

In use, the controller 24 may operate to receive instructions from a user through the control panel 30 and/or the display panel 28 to selectively print one or more pages of a stored document. By way of example, the control panel 30 may comprise a numeric keypad having “*” and “#” symbols. The “*” and “#” symbols may function as separators between selected pages. In this respect, the “*” symbol may function as a “,” and the “#” symbol may function as a “-”. Thus, for instance, a user may select to print pages “1-4, 7, 9-”. The user's selection may appear on the display panel 28 such that the user may verify their selection. In response to receipt of the instructions, the controller 24 may access the print memory 22, preferably where the document file is stored, and cause the print module 26 to print the selected page(s) of the document.

In addition, the controller 24 may operate to receive instructions from a user through the control panel 30 to display the selected page(s) of the stored document. In response to receipt of the instructions, the controller 24 may control the display panel 28 to display the selected pages.

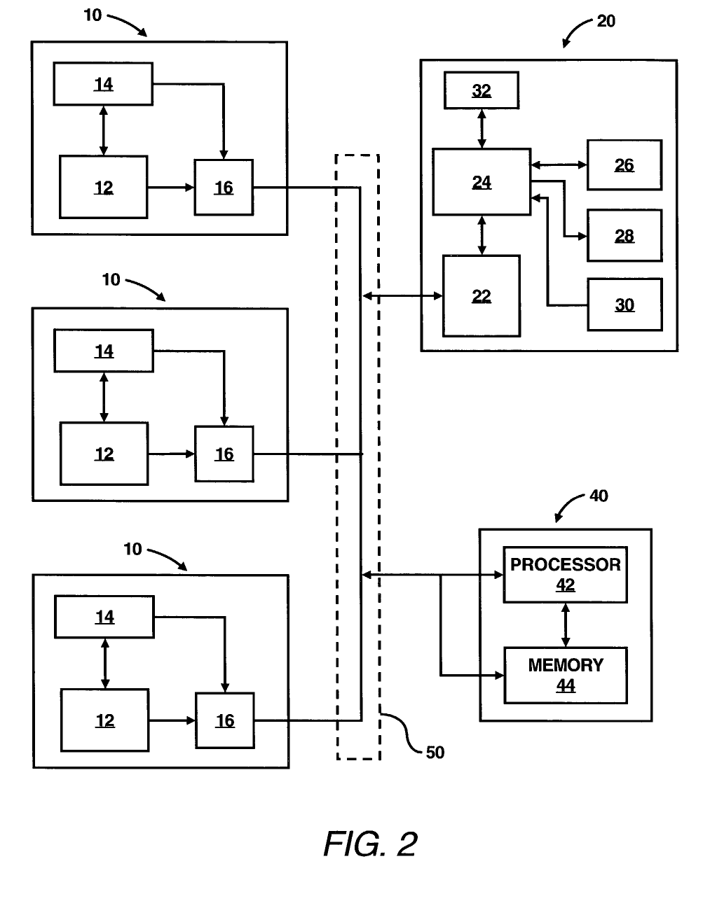

FIG. 2 illustrates an exemplary block diagram of a plurality of host devices 10, a printing device 20 and a network server 40 in accordance with another embodiment of the present invention. As described hereinabove, each of the host devices 10 may include a CPU 12 configured to execute application software that may pass print commands, e.g., sending a file from a memory 14 to the printing device 20 for printing. A print driver 16 is coupled to the CPU 12 and generally operates to format document files stored in memory 14 for printing at the printing device 20. In this embodiment, the plurality of host devices 10 may all be coupled to a communication network 50 that is controlled by a network server 40. In addition, the printing device 20 may be coupled to the communication network 50 and may provide print services to all of the host devices 10 coupled to the communication network 50.

As also described hereinabove, the printing device 20 may include a controller 24 configured to execute a set of programs stored in a print memory 22. The printing device 20 may also include a print module 26 configured to apply printing material (not shown), e.g., toner, inkjet fluid, etc., onto a print medium. The printing device 20 may also include a display panel 28, a control panel 30, and a timer module as described hereinabove.

The network server 40 may include a processor 42 and a memory 44. The configuration of the server 40 and the operations it may perform are generally known to those skilled in the art.

The print memory 22 disposed in the printing device 20 may include a plurality of directories each associated with one of the host devices 10 and each designated to store documents received from the associated host device 10. The controller 24 may maintain a print queue (not shown) containing the names of the document files stored in various directories arranged, for example, according to the order in which the document files are arranged in the print queue. If one of the document files listed in the master list is selected by a user for display, then the controller 24 may temporarily remove the name of the selected document file from the print queue until display of the selected document is complete.

As described with respect to FIG. 1, the printing device 20 and host devices 10 shown in FIG. 2 may be adapted to communicate wirelessly. More specifically, the communication network 50 may comprise a wireless communication network. For example, the printing device 20 and host devices 10 may be adapted to include wireless communication devices (not shown) that enable wireless communication via a wireless communication protocol such as BLUETOOTH. Alternatively, for example, the host devices 10 may be adapted to access the printing device 20 via a telephone modem.

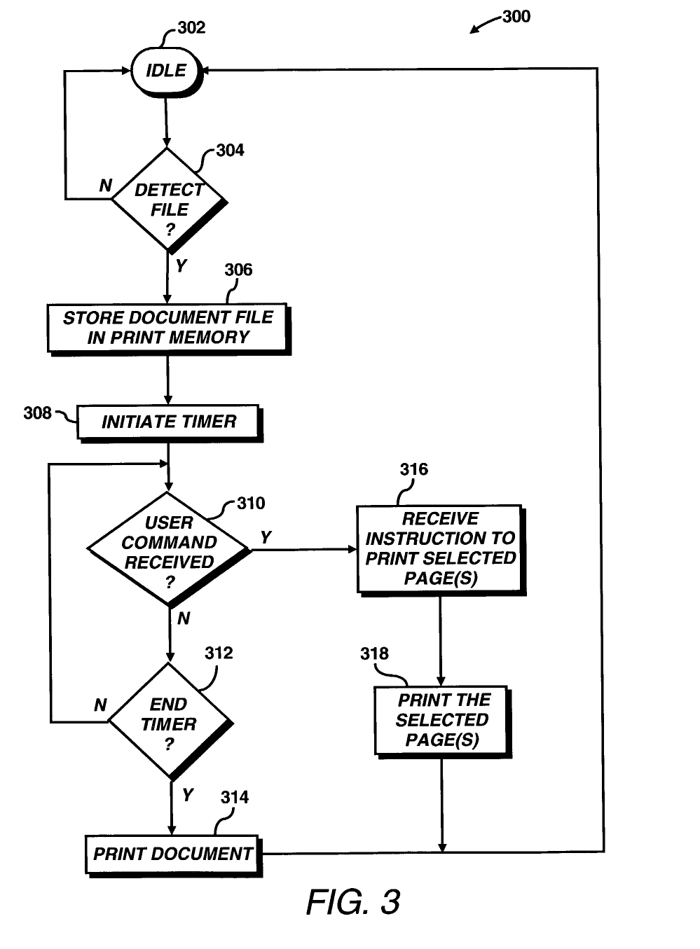

Referring to FIG. 3, there is illustrated an exemplary flow diagram of a method 300 according to a preferred embodiment of the present invention. The steps illustrated in the method 300 may be contained as a utility, program, subprogram, in any desired computer accessible medium, which can exist in a variety of forms both active and inactive. For example, the method 300 may be implemented in program(s) comprised of program instructions in source code, object code, executable code or other formats. Any of the above can be embodied on a computer readable medium, which include storage devices and signals, in compressed or uncompressed form.

Exemplary computer readable medium include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD-ROM or via Internet download. In a sense, the Internet itself, as an abstract entity, is a computer readable medium. The same is true of computer networks in general. Although particular reference is made in the following descriptions of FIG. 3 to the controller 24 illustrated in FIGS. 1 and 2 as performing certain printing device functions, it is to be understood that those functions may be performed by any electronic device capable of executing the above-described functions.

With particular reference to FIG. 3 and FIGS. 1 and 2, according to an embodiment of the present invention, the printing device 20, e.g., a printer, photocopier, etc., may initially be in an idle mode, e.g., sleep, shutdown, and the like (step 302). The controller 24 of the printing device 20 may detect whether a file is sent for printing (step 304). The file for printing may be received from a host device 10, e.g., a computer, laptop computer, scanning apparatus (e.g., photocopier, facsimile machine, etc.), PDA, and the like.

If no file is detected, the printing device 20 may return to the idle mode (step 302). If a file is detected, the received file may be stored in the print memory 22 (step 306). An optional timer 32 may be initiated (step 308) upon storage of the file in the printing device memory 22. One purpose of the timer 32 is to enable a user with a predetermined amount of time to select to print certain pages of the document and/or to display the image(s) of one or more of the selected pages on the display panel 28.

If a user command is not received at step 31 0, the timer 32 may expire (step 312) and the printing device 20 may begin printing the document (step 314). In this respect, absent input from a user, the document may be printed without substantially undue delay (step 314). The timer 32 may be set with a default value and may be raised according to user needs.

At step 310, the printing device 20 may receive a command, preferably through the control panel 30, to print one or more selected pages of a document (step 316). The selection of pages of the document to print may be input through the control panel 30, for example, a keypad and/or a touch sensitive screen (not shown). For instance, the keypad may comprise a numeric or an alpha-numeric keyboard, and a user may selectively input the desired page numbers to print these selected pages. The keypad may be configured to enable a user to input page numbers in random order and/or in a continuous order (e.g., “1-4, 7, 8-”). In addition, the display panel 28 may be configured to display a keypad, e.g., numeric or alphanumeric, and may comprise a touch-sensitive screen (control panel 30) designed to receive the user commands. The display panel 28 may also be configured to display a list of page numbers that a user may selectively choose to print.

In response to receipt of instructions to print the one or more selected pages of the document (step 316), the selected pages may be printed. In this respect, the controller 24 may access the print memory 22 to cause the one or more selected pages to be printed by the print module 26 (step 318).

Although not illustrated in FIG. 3, the control panel 30 and/or the display panel 28 may include an input device for canceling the print job. The canceling input device may function to cause cancellation of the printing operation at any time following receipt by the printing device of the file. Thus, for instance, the printing operation may be canceled following receipt of instructions to print one or more pages (step 316) or prior to or during the printing operation (step 314).

It should be understood that some or all of the various commands described above may be combined. As an example, the printing device 20 may receive a command to cancel the print job after a user has viewed the contents of each document image.

Upon completion of any one of steps 314 and 318, the controller 24 may operate the printing device 20 to enter into the idle mode 302 to await receipt of another document to print.

It will be apparent to one of ordinary skill in the art that some of the steps may be omitted from the method 300 may be performed in different orders without departing from the spirit and scope of the invention.

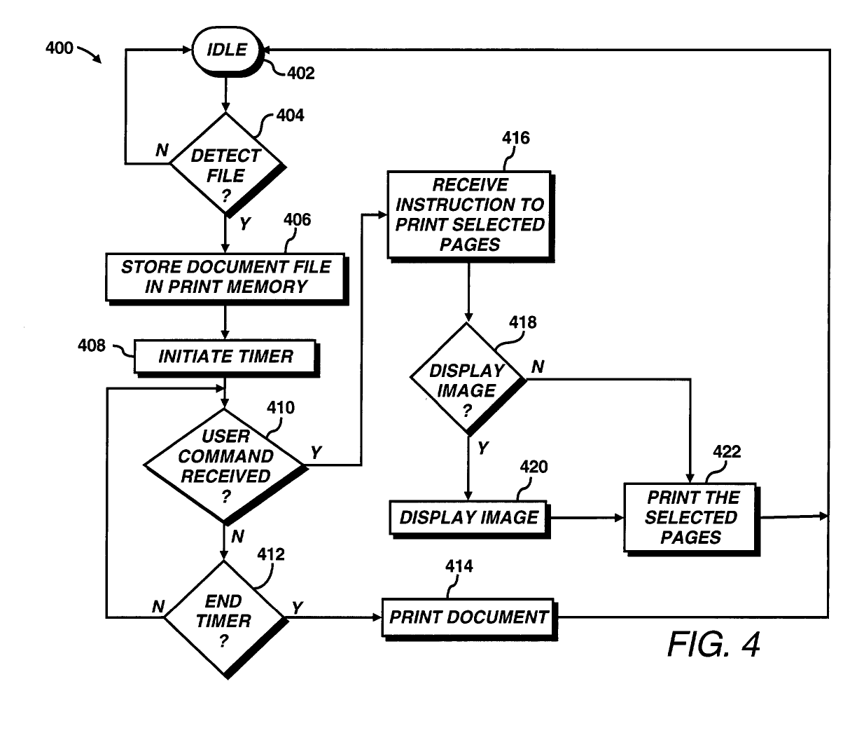

With reference now to FIG. 4 and FIGS. 1 and 2, there is illustrated a flow diagram of a method 400 in accordance with another embodiment of the invention. The steps contained in the method 400 are similar to those described above with respect to the method 300. More specifically, the steps 402-416 are similar to steps 302-316. Therefore, a detailed description of the manner in which the method 400 may be implemented as well as the steps 402-416 is omitted. Instead, the description provided hereinabove with respect to FIG. 3 is generally relied upon to provide this information.

At step 418, the printing device 20 may receive a command to display images of the document, also preferably through access of the control panel 30. The selection of files to be selectively printed and/or viewed need not be dependent upon the order in which the files were stored in the print queue. In this respect, the printing device 20 may be controlled to print selected pages and/or display images of virtually any document file stored in the print memory 22. It should be understood that the selection to view the images of the formatted file may be chosen in a variety of alternate manners.

In response to receipt of instructions to display the images of the document file, the controller 24 may operate the display panel 28 to display images of the selected pages (step 420). Upon display of the images, the controller 24 may receive instructions to proceed with printing of the selected pages (step 422), in a similar manner to that described above with respect to step 318. Otherwise, the controller 24 may receive a command to cancel printing (not shown). If the printing device 20 does not receive a command to display images of the selected pages, the printing device 20 may proceed to print the selected pages (step 422).

Alternatively, the user command received at step 410 may cause the image of the document pages to be displayed, preferably on the display panel 28, prior to receipt of instructions to print one or more selected pages. In this respect, a user may view the pages of the document before deciding which of those pages are to be printed.

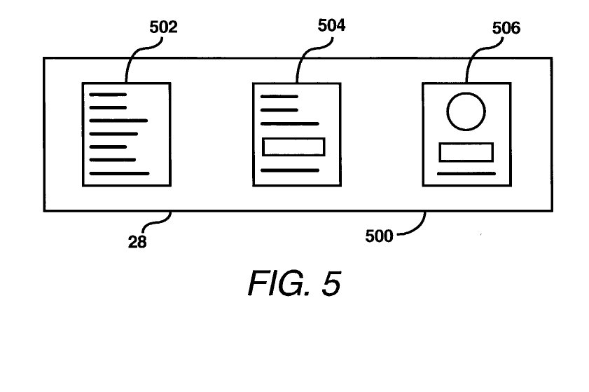

In addition, the display of the document pages may be varied on the display panel 28. Under this command, the controller 24 may operate to display variations of the document images or selected pages. Thus, for example, illustrated in FIG. 5, is an exemplary screenshot 500 of document images 502-506 on the display panel 28. The document images 502-506 may be replaced with a subsequent set of document images, e.g., document images representing the next three pages of a document. In addition, some or all of the document images may be displayed to enable a user to proof each page of the document prior to printing.

Furthermore, a display during printing command may also be received as part of the display image step 418. Under this command, the controller 24 may operate to display images on the display panel 28 of the document pages during printing of the document. In this respect, a user may see the pages of the document during printing thereof without removing the printed pages from a post-processing apparatus, e.g., stapler, collator, storage bin, etc.

It should be understood that some or all of the various commands described above may be combined. As an example, during the display of the document images during printing (step 422), the printing device 20 may receive a command to cancel the print job. As another example, the printing device 20 may receive a command to cancel the print job after a user has viewed the contents of each document image.

Upon completion of any one of steps 414 and 422, the controller 24 may operate the printing device 20 to enter into the idle mode 402 to await receipt of another document to print.

It will be apparent to one of ordinary skill in the art that some of the steps may be omitted from the method 400 may be performed in different orders without departing from the spirit and scope of the invention.

By virtue of the above-described embodiments of the present invention, only those pages of a document selected through the printing device may be printed. In addition, the selected pages of the document may be displayed to a user prior to selection to print and or during printing of the selected pages. In one sense, the user is generally enabled to selectively print pages of a document without solely relying on the names of the documents. In another sense, the user may print certain pages of selected documents, also by viewing the pages of the document themselves. Further, the user may verify that a correct document and/or selected pages are being printed during the printing operation by viewing the pages substantially concurrently with the printing thereof. In this respect, the amount of wasted print medium may substantially be reduced by allowing users to more accurately select the documents and/or pages they wish to print with a printing device.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method for printing one or more pages of a document at a printing device having a control panel, said method comprising steps of:
storing a document file in a memory of said printing device;
receiving instructions through said control panel to print one or more selected pages of said document; and
printing said one or more selected pages of said document.

2. The method according to claim I, further comprising:
initiating a timer with a predetermined amount of time;
waiting for a user command within said predetermined amount of time; and
printing the document in response to said timer expiring.

3. The method according to claim 1, wherein said step of receiving instructions comprises receiving instructions to selectively print individual pages and/or groups of pages of said document.

4. The method according to claim 1, wherein said step of printing said one or more pages of said document comprises selectively printing less than all of the pages of the document.

5. The method according to claim 1, further comprising:
displaying an image of said selected one or more pages of said document on a display panel of said printing device.

6. The method according to claim 5, wherein said step of displaying said images of said selected pages comprises displaying said images during printing of said selected pages.

7. The method according to claim 1, further comprising:
canceling the printing of said one or more selected pages in response to receipt of a command to cancel printing.

8. A device for printing at least one page of a document, said printing device comprising:
a print module for printing pages of documents;
a controller coupled to said print module;
a memory coupled to said controller for storing one or more documents; and
a control panel operable to receive instructions to print at least one selected page of said one or more documents, wherein said controller is configured to control said print module to print said selected at least one page.

9. The device according to claim 8, further comprising:
a timer module for initiating printing of a document in response to a predetermined amount of time expiring without receipt of a user command.

10. The device according to claim 8, wherein said control panel is operable to receive to print individual pages and/or groups of pages of said document.

11. The device according to claim 8, wherein said controller is operable to print less than all of the pages of the document.

12. The device according to claim 8, wherein said control panel comprises one of a multifunction keypad having one or more keys, a numeric keypad and an alpha-numeric keypad.

13. The device according to claim 8, wherein said control panel comprises a touch sensitive screen.

14. The device according to claim 13, wherein said touch sensitive screen is operable to display references of the pages of the documents and wherein said touch sensitive screen is further operable to receive input of the at least one page to print and relay said input to the controller.

15. The device according to claim 8, further comprising:
a display panel coupled to said controller for displaying one ore more images of said at least one selected page; and
wherein said controller is operable to display at least a portion of said at least one selected page of said document on said display panel.

16. The device according to claim 8, wherein said controller is operable to cancel printing of said at least one selected page of said document.

17. A computer readable storage medium on which is embedded one or more computer programs, said one or more computer programs implementing a method for printing one or more pages of a document in a printing device having a control panel, said one or more computer programs comprising a set of instructions for:
storing one or more document files in a memory of said printing device; and
receiving instructions through said control panel to print one or more selected pages of said document; and
printing said one or more selected pages of said document.

18. The computer readable storage medium according to claim 17, said one or more computer programs further comprising a set of instructions for:
receiving instructions to print individual pages and/or groups of pages of said document.

19. The computer readable storage medium according to claim 17, said one or more computer programs further comprising a set of instructions for:
displaying an image of one or more pages of said document on a display panel of said printing device.

20. The computer readable storage medium according to claim 17, said one or more computer programs further comprising a set of instructions for:
canceling the printing of said at least one selected page in response to receipt of a command to cancel printing.
